(19) United States
(12) Patent Application Publication
(10) Pub. No.: US 2018/0130147 A1
(43) Pub. Date: May 10, 2018

(54) Coaster with illumination communication

(71) Applicant: Robert M. Hahn, Colts Neck, NJ (US)

(72) Inventor: Robert M. Hahn, Colts Neck, NJ (US)

(21) Appl. No.: 15/330,786

(22) Filed: Nov. 7, 2016

(51) Int. Cl. G06Q 50/12; F21V 23/02; F21V 23/04; F21V 33/00; G06Q 30/06

(52) U.S. Cl. CPC G06Q 50/12; F21V 23/02; F21V 23/0414; F21Y 2115/10; F21V 33/0036; G06Q 30/0601; F21V 23/0442

(57) ABSTRACT

A coaster with illumination communication for signaling a drink refill request and for signaling a check request includes: a) a base assembly having a flat top for resting a drinking vessel thereon, and having a hollow body for holding illumination, power and switching components, the flat top having at least a portion thereof being at least translucent; b) an illumination component located in the base assembly positioned to direct light to the flat top; c) a power component located in the base assembly and connected to the illumination component; d) a switching component electrically connected to the power component and the illumination component so as to control the illumination component with at least 3 modes, and thus being an at least three mode switching component, the at least three modes being an off mode and two different on modes. Methods are also included.

### REFERENCE TO RELATED APPLICATIONS

The present application is not related to any pending or issued United States of America or foreign patent or patent application.

### BACKGROUND OF INVENTION

### a. Field of Invention

The present invention generally relates to devices and methods to be used in restaurant and bar establishments. Specifically, coasters have been developed that provide multiple services to customers. These services include illumination signals to order refills on beverages and to separately request a final tab or bill for purchases. The coasters will offer at least two switch positions in addition to an inoperative or off position. These two active positions include one for beverage refill and the other for requesting the bill. These will activate different modes of illumination so that the waiter or waitress will know and understand the signal presented by the user.

### b. Description of Related Art

The following patents are representative of the field pertaining to the present invention:

U.S. Pat. No. 7,353,136 B2 to Vock et al describes a system for ordering drink refills, comprising a coaster body with a processor, a wireless transmitter and at least one button, the processor responding to user inputs to activate the wireless transmitter to transmit wireless signals indicative of a desired order.

U.S. Pat. No. 6,793,363 B2 to Jensen describes an illuminated coaster which includes a base with a body having upper and lower ends and a generally frusto-conical configuration enclosing a compartment. A resilient, insulative sleeve comprising foam rubber, polyurethane or some other suitable material is mounted on the body upper end and forms a container receiver adapted to selectively receive the lower end of a container. A lighting system is located generally in the compartment and includes a power source, such as a battery set. A light source is selectively connected to the battery set through a switching component and can comprise a bulb and socket or an LED, either of which can be mounted below the transparent lens for projecting light upwardly into a container in the container receiver. Modified embodiments of the illuminated coaster include horizontal/annular, helical and vertical ribs located on the inside of the sleeve for engaging a container received therein.

U.S. Pat. No. 6,354,711 B1 to McCoy describes a glowing coaster composed of a base, an LED light source installed in the base, an upper assembly consisting of an absorbent pad and housing and a wall transformer power source, which when plugged into a wall receptacle, causes the LED to light and create a glowing effect to the outer surface of a portion of the base or the upper assembly allowing the device to be easily located in a darkened room.

U.S. Pat. No. 6,305,817 B1 to Johnston et al describes a holder for a container (of beverage, for example) having a compartment, at least partly of light transmitting material to permit light to be transmitted to and from the compartment. The housing has a central axis that is vertical when the housing is upright, and a wall that encloses the axis and forms the outer side wall of the compartment. A cover is supported on the upper edge of the side wall and overlies the compartment. The cover includes a support and holding device in which a container can be received and removed by relative axial movement between the container and holder, and which is operable to support upright a container received therein upright on the side of the cover opposite the compartment, and to restrain the container against separation from the holder with a restraining force that will cause the container and holder to move as a unit when lifting force is applied only to the container, but which restraining force can be selectively overcome by pulling the container and holder apart from each other. A light-emitter in the form of an EL lamp comprising a laminate including ZnS phosphor particles may be received in the compartment with a circuit that is responsive to a pre-selected condition (e.g., the upright position of the holder) to activate the EL lamp, and to deactivate it in the absence of the pre-selected condition.

U.S. Pat. No. 6,092,905 to Koehn describes an illuminated beverage container holder for illuminating the area around the beverage container held therein so that a user may easily locate the beverage container in low light conditions. The illuminated beverage container holder includes a base with a perimeter side wall upwardly extending therearound to define a receptacle designed for receiving therein a beverage container. The perimeter side wall has an outwardly radiating annular lip around a top edge of the perimeters.

U.S. Pat. No. 6,065,848 to Tucker et al describes a base, for use with and for illuminating the interior of a container for liquids, and which has a bottom wall portion at least partly transparent to light, comprising a main body comprised of an upwardly-disposed side wall whose height is substantially less than that of the container, a bottom wall adapted to carry, or having holder structure for holding, at least one battery in a substantially horizontal position, a mount for a light bulb, electrical conductors and support structure for supporting a container thereon, to illuminate the interior of a container supported on the base through the container bottom wall portion. The base can include securement structure for securing the base to the container to reside under its bottom end portion so that when the container is lifted, the base is lifted with the container.

U.S. Pat. No. 5,307,250 to Pearson describes a light-up coaster for beer bottles, and the like, has an outer housing in which is vertically-slidable an inner housing. The upper surface of the inner housing is used to support a bottle thereon, and a spring biases the inner housing upwardly. A pair of switches is controlled by the movement of the inner housing. The first switch is a normally-closed switch, and the second switch is a normally open switch. The two switches are arranged in series with a light bulb and battery power-source. When there is no bottle supported on the upper surface of the inner housing, the upper surface of the inner housing is raised by the spring to its highest level and into abutting contact with an interior, upper, annular lip of the outer housing. In this state, the first switch is closed but the second switch is open. When a full bottle of beer, or the like, is supported on the upper surface of the inner housing, the inner housing is lowered against the force of the spring, and the first switch is open and the second switch is closed. When the bottle is empty, then the inner housing is raised slightly to close the first switch again but still keeping the second switch in its closed state, whereby the light bulb is illuminated.

U.S. Pat. No. 4,858,084 to Sheryll describes an illuminated coaster having a minimum number of parts for facilitating assembly and reducing manufacturing costs includes an integral base defining structure for receiving a light, at least one battery, battery contacts, and a switch means for lighting the light when a drinking vessel is disposed in the coaster.

U.S. Pat. No. 4,344,113 to Ditto et al describes a device for illuminating a liquid drink for use at a party or a social event to give the appearance of an illuminated liquid. The device has a light adapted to colimate a beam of light through the transparent bottom of the glass receptacle into the liquid and be dispersed therein. Rechargeable or non-rechargeable batteries are secured within the base to act as a power source for the light. A switch means comprising of upwardly contacts to contact a conductive ring of the base of the glass receptacle forms the on or off means for the switch. A modified form would utilize a coaster which may be used with stem ware and would be activated by the weight of the glass upon the coaster. The still modified form would be formed by a manual operated switch which may be used with the light formed in a chamber formed in the box under the glassware. A charger base utilizing inductive principles is used to recharge rechargeable batteries if used in that particular embodiment.

U.S. Pat. No. 4,336,574 to Goodman describes a lighted coaster for supporting beverage containers such as glasses. The improvement provides a top cover having a translucent lens and a side skirt extending downwardly to overlap a base member. The base contains batteries and a spring-biased light bulb extending upwardly to contact the underside of the lens in such a fashion that when beverage glasses are placed on the coaster, the light moves downwardly to contact a suitably disposed circuit member and actuate the light. When the beverage is removed, the light urges the cover upwardly a short distance and breaks contact with the electric circuit and turns itself off.

U.S. Pat. No. 4,261,026 to Bolha describes a lighted coaster for drinks provides a base with a light source, a reflector adjacent the light source and a translucent supporting surface upon which a glass can be placed.

U.S. Pat. No. 3,878,386 to Douglas describes a lighted beverage glass having a stem with a central bore extending therethrough. A cup-shaped glass mounting portion is provided at the top of the stem and has a glass shell member removably mounted therein. A plurality of horizontally extending gripping ribs is provided on the mounting portion to securely retain the glass therein. An annular shoulder is formed at the top portion of the central bore. A light assembly is mounted in the central bore of the stem for directing light through the bottom of the glass. The light assembly includes an electric bulb, a dry cell battery and a spring member mounted between the bulb and the battery. The annular shoulder serves as a seat for the electric bulb.

U.S. Pat. No. 2,745,947 to Sansous describes an electrically illuminated drinking glass holder, a flat circular base, an annular flange rising from said base inwardly of and concentrically with respect to the edge thereof, said base and flange being formed as a unit from an insulating material, a pair of spaced elongate plates resting on said base within the confine of said flange, upstanding portions at the end of each of said plates for the positioning of a dry cell therebetween, an inverted U-shaped part connecting said plates at their centers, a socket for an electric lamp bulb mounted in the center of the medial portion of said U-shaped part, an electric switch supported on said base between adjacent ends of said plates and having its operating button projecting outwardly through said flange, the dry cells, switch and socket being electrically connected, a dome shaped transparent wall overlying said dry cells and the lamp bulb socket and resting on said flange, a vertical tubular member having its lower end seated over said flange and its upper end outwardly flared, and means on the inside of said tubular member for holding engagement with the edge of said transparent wall when the tubular member is disposed in seated position with respect to the base and said flange.

U.S. Pat. No. 1,389,132 to Galavan describes a device of the kind described, a liquid container provided with an inclosing wall pervious to light and a supporting member for said container provided with a wall impervious to light and arranged to support the container in an elevated position, in combination with a plurality of different colored lights arranged beneath the container, means for automatically lighting said members, and air chambers arranged between the lights and the bottom of the container. A device of the kind described, a liquid container provided with an inclosing wall pervious to light and a supporting member for said container provided with a wall impervious to light and arranged to support the container in an elevated position, in combination with a plurality of different colored lights arranged beneath the container, means for automatically operating said lighting members and a plurality of air chambers arranged between the lighting members and the bottom of the container.

Notwithstanding the prior art, the present invention is neither taught nor rendered obvious thereby.

### SUMMARY OF INVENTION

The present invention is directed to methods and devices for a coaster with illumination communication for signaling a drink refill request and for signaling a check request, which includes: a) a base assembly having a flat top for resting a drinking vessel thereon, and having a hollow body for holding illumination, power and switching components, the flat top having at least a portion thereof being at least translucent; b) an illumination component located in the base assembly positioned to direct light to the flat top; c) a power component located in the base assembly and connected to the illumination component; d) a switching component electrically connected to the power component and the illumination component so as to control the illumination component with at least 3 modes, and thus being an at least three mode switching component, the at least three modes being an off mode and two different on modes.

In some embodiments of the present invention coaster with illumination communication for signaling a drink refill request and for signaling a check request, the illumination component is selected from the group consisting of LED lamp, LED flat light sheet and combinations thereof.

In some embodiments of the present invention coaster with illumination communication for signaling a drink refill request and for signaling a check request, the illumination component is a plurality of LED lamps.

In some embodiments of the present invention coaster with illumination communication for signaling a drink refill request and for signaling a check request, the power component is selected from the group consisting of a battery, a fuel cell, and other portable power components.

In some embodiments of the present invention coaster with illumination communication for signaling a drink refill request and for signaling a check request, the base assembly includes an access port for replacing the power component.

In some embodiments of the present invention coaster with illumination communication for signaling a drink refill request and for signaling a check request, the switching component is a three way switch having an off mode position and two diverse powering mode positions.

In some embodiments of the present invention coaster with illumination communication for signaling a drink refill request and for signaling a check request, the three way switch includes an off mode position, one on mode position for steady illumination, and one on mode position for intermittent illumination.

In some embodiments of the present invention coaster with illumination communication for signaling a drink refill request and for signaling a check request, the three way switch includes an off mode position, one on mode position for slow intermittent illumination, and one on mode position for fast intermittent illumination.

In some embodiments of the present invention coaster with illumination communication for signaling a drink refill request and for signaling a check request, the switching component is at least two different on-off two way switches with diverse on modes.

In some embodiments of the present invention coaster with illumination communication for signaling a drink refill request and for signaling a check request, the switching component includes at least one mode that includes a weight-activated mechanism.

In some embodiments of the present invention a method of signaling for a drink refill request and for signaling a check request by a user, includes: A) providing the user with a coaster which includes: a) a base assembly having a flat top for resting a drinking vessel thereon, and having a hollow body for holding illumination, power and switching components, the flat top having at least a portion thereof being at least translucent; b) an illumination component located in the base assembly positioned to direct light to the flat top; c) a power component located in the base assembly and connected to the illumination component; d) a switching component electrically connected to the power component and the illumination component so as to control the illumination component with at least 3 modes, and thus being an at least three mode switching component, the at least three modes being an off mode and two different on modes, one of the two different on modes being for signaling a request for a drink refill, and the other of the two different on modes for signaling a request for a check; and B) directing the user to activate one of the two different on modes for signaling a request for a drink refill, and to activate the other of the two different on modes for signaling a request for a check.

In some embodiments of the present invention method of signaling for a drink refill request and for signaling a check request by a user, the illumination component is selected from the group consisting of LED lamp, LED flat light sheet and combinations thereof.

In some embodiments of the present invention method of signaling for a drink refill request and for signaling a check request by a user, the illumination component is a plurality of LED lamps.

In some embodiments of the present invention method of signaling for a drink refill request and for signaling a check request by a user, the power component is selected from the group consisting of a battery, a fuel cell, and other portable power components.

In some embodiments of the present invention method of signaling for a drink refill request and for signaling a check request by a user, the base assembly includes an access port for replacing the power component.

In some embodiments of the present invention method of signaling for a drink refill request and for signaling a check request by a user, the switching component is a three way switch having an off mode position and two diverse powering mode positions.

In some embodiments of the present invention method of signaling for a drink refill request and for signaling a check request by a user, the three way switch includes an off mode position, one on mode position for steady illumination, and one on mode position for intermittent illumination.

In some embodiments of the present invention method of signaling for a drink refill request and for signaling a check request by a user, the three way switch includes an off mode position, one on mode position for slow intermittent illumination, and one on mode position for fast intermittent illumination.

In some embodiments of the present invention method of signaling for a drink refill request and for signaling a check request by a user, the switching component is at least two different on-off two way switches with diverse on modes.

In some embodiments of the present invention method of signaling for a drink refill request and for signaling a check request by a user, the switching component includes at least one mode that includes a weight-activated mechanism.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE SEVERAL VIEWS OF THE DRAWINGS(S)

The accompanying drawings, which are included to provide a further understanding of the invention and are incorporated in and constitute a part of this specification, illustrate preferred embodiments of the invention and together with the detailed description serve to explain the principles of the invention. In the drawings:

FIG. 1 is a block diagram of some embodiments of the present invention, setting forth the parameters of some present invention coaster with illumination communication for signaling a drink refill request and for signaling a check request;

FIG. 2 is a block diagram of some embodiments of the present invention, setting forth details of some present invention coaster with illumination communication for signaling a drink refill request and for signaling a check request, focusing on the switchings;

FIG. 3 is a front, partially cut view of one embodiment of a present invention coaster with illumination communication wherein a user may select a drink refill mode or a check request mode wherein different lighting sequences are determinative of the mode;

FIG. 4 shows a front view of an alternative present invention coaster;

FIG. 5 shows a top view of present invention coaster with identical parts shown in FIG. 4 identically numbered;

FIG. 6 is a wiring diagram for one embodiment of the present invention coaster with illumination communication that could be used in many embodiments, including the present invention coaster shown in FIG. 3; and,

FIG. 7 is another wiring diagram for different embodiments of present invention coasters wherein various lighting feature options are included.

### DETAILED DESCRIPTION OF THE EMBODIMENTS

The present invention coasters perform three unique functions: providing a signaling method for letting an establishment know that service is required; providing a different signaling method for indicating to an establishment that the customer(s) are finished and want a check or tab; and providing interesting mood lighting that shines upwardly through the top of the coaster and into and through a glass resting upon it. This third feature is very dramatic, and even beautiful in a low lit environment, such as a club or upscale restaurant.

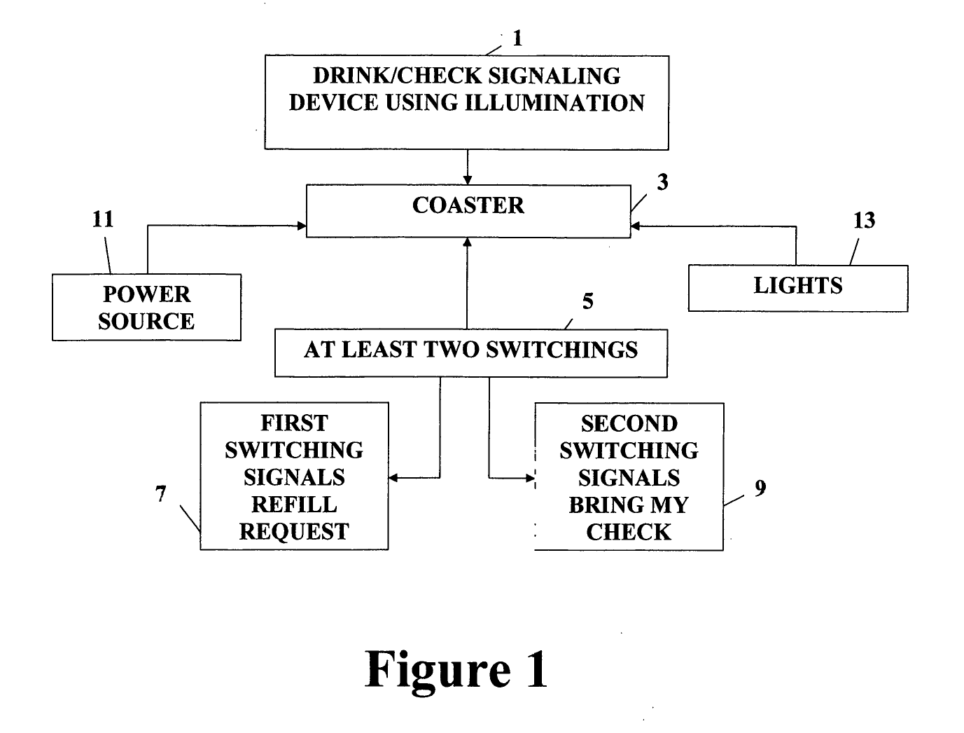

FIG. 1 is a block diagram of some embodiments of the present invention, setting forth the parameters of some present invention coaster with illumination communication for signaling a drink refill request and for signaling a check request. It includes block 1 drink/check signaling device using illumination, block 3 coaster, and block 5 at least two switchings. It further includes block 7 first switching signals refill request and block 9 second switching signals bring my check. It also includes block 11 power source and block 13 lights.

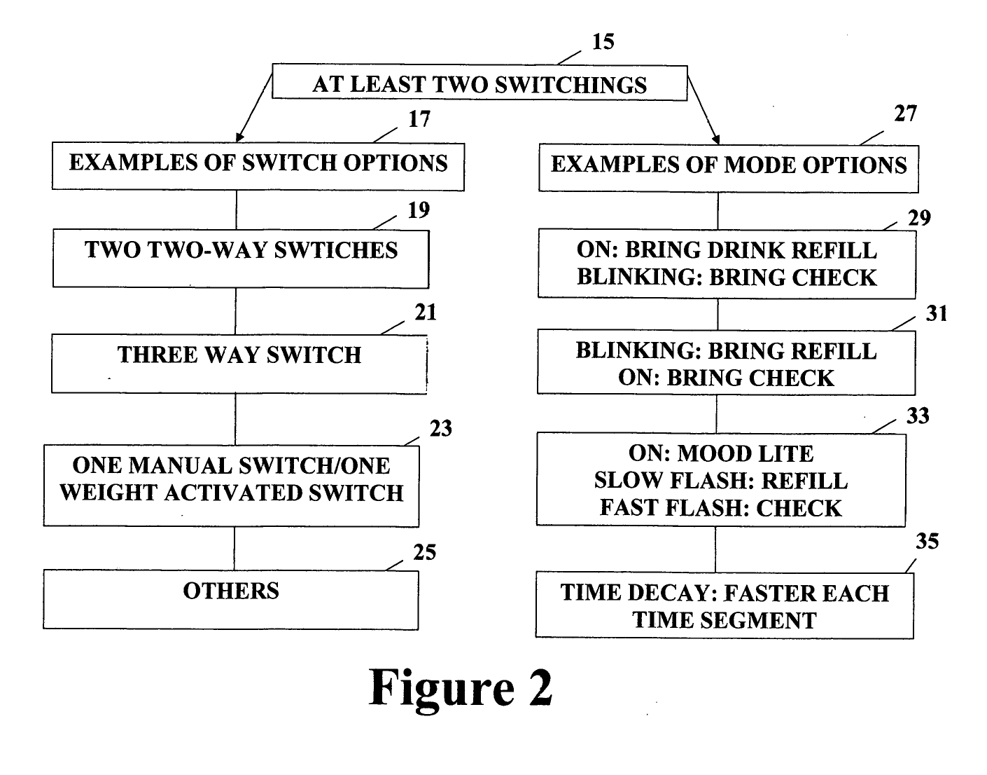

FIG. 2 is a block diagram of some embodiments of the present invention, setting forth details of some present invention coaster with illumination communication for signaling a drink refill request and for signaling a check request, focusing on the switchings. By “switchings” is meant the acts of throwing switches. The word “switchings” is different from switches because a single switch can have two positions (on and off, for example) or three positions or more. Alternatively, more than one switch can equivalently or effectively provide for three or more positions. Thus, “switchings” represents possible movements, without specifying the actual number of switches involved. Referring again to FIG. 2, it includes block 15 at least two switchings, block 17 examples of switch options, block 19 three way switch, and block 21 two two-way switches. It further includes block 23 one manual switch/one weight activated switch, block 25 others, block 27 examples of mode options, and block 29; on: bring drink refill, blinking: bring check. It also includes block 31; blinking: bring refill, on: bring check, block 33; on: mood lite, slow flash: refill, fast flash: check, and block 35 time decay: faster each time segment.

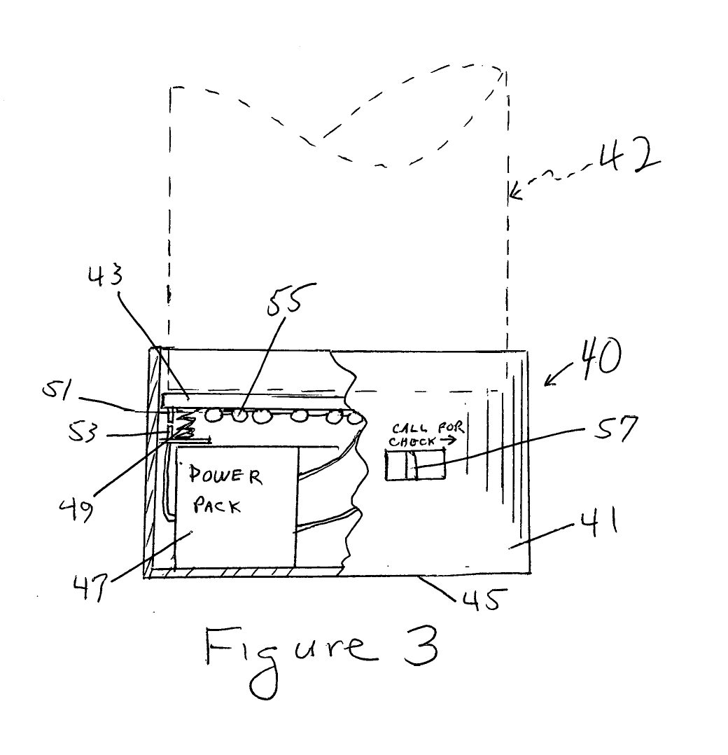

FIG. 3 is a front, partially cut view of one embodiment of a present invention coaster 40 with illumination communication wherein a user may select a drink refill mode or a check request mode wherein different lighting sequences are determinative of the mode. Coaster 40 has base assembly 41 that has a bottom 45 with a hinged or removable door for inserting batteries or other power sources for power pack 47. Base assembly 41 has a side wall and has a spring-based flat top 43, as shown. Top 43 is mounted on two springs, such as spring 49.When a beverage vessel, such as beer glass 42, rests upon top 43, the weight of the glass, even when empty, will press down on the springs and close contacts 51 and 53 to complete a circuit to light up LED bulbs, such as LED bulb 55. The light will shine through top 43 and light up glass 42, as well. Independently, side switch 57 is a call for check button. When customers would like their check, they will slide switch 57 from left to right. This will override the steady light from the glass, or, if there is no glass, the LED bulbs will blink, signaling the waiter or waitress for the tab.

The following Table 1 illustrates the modes of the coaster shown in FIG. 3:

TABLE 1
FIG. 3 Coaster Modes

| | REFILL | CHECK | |
|---|---|---|---|
| MODE | REQUEST | REQUEST | LIGHTS |
| 1. OFF/OFF | NO GLASS | LEFT(OFF) | OFF |
| 2. ON/OFF | GLASS | LEFT(OFF) | ON |
| 3. OFF/ON | NO GLASS | RIGHT(ON) | BLINKING |
| 4. ON/ON | GLASS | RIGHT(ON) | BLINKING |

Mode 1 to Mode 2 is one switching possibility; Mode 1 to Mode 3 is a second switching possibility; Mode 4 yields the same result as Mode 3.

FIG. 4 shows a front view of an alternative present invention coaster 60. Coaster 60 includes a base assembly 61 that has a square outer shape and a circular top view inside top section. It has four flat, right-angled (diamond) shaped side walls, such as side wall 63, a bottom 65 with access for battery replacement and a hollow central area 67 for containing batteries, lights, wiring, switches and optional controllers or chips. In this case, top 69 is not a floating top as in FIG. 3 above, but is translucent or more preferably transparent. The coaster may be used to hold a beverage container such as mug 62. The proportions are exaggerated to emphasize the invention, but, in reality, the coaster 60 may be less than one inch in height. In any event, it will function as a normal coaster except that button 71 may be thrown to switch on the lights, such as light 73, in hollow central area 67. When switch 71 is turned on the lights will be illuminated on a constant basis and it will signal the establishment (bartender, waiter or waitress) to come to the table for more service, such as drink refills. When switch 75 is turned on, the lights will shine intermittently, regardless of the position of switch 71 and thus will signal a request for a tab.

The present invention coaster 60 of FIG. 4 does not rely upon a spring or the weight of a glass and thus might be used for an entire evening as a coaster and illumination will be manually effectuated as needed. The switch 71 is an equivalent switching to the spring and contacts mechanism of FIG. 3. For this reason, the first three modes of Table 1 above will be the same for this present invention FIG. 4 coaster 60.

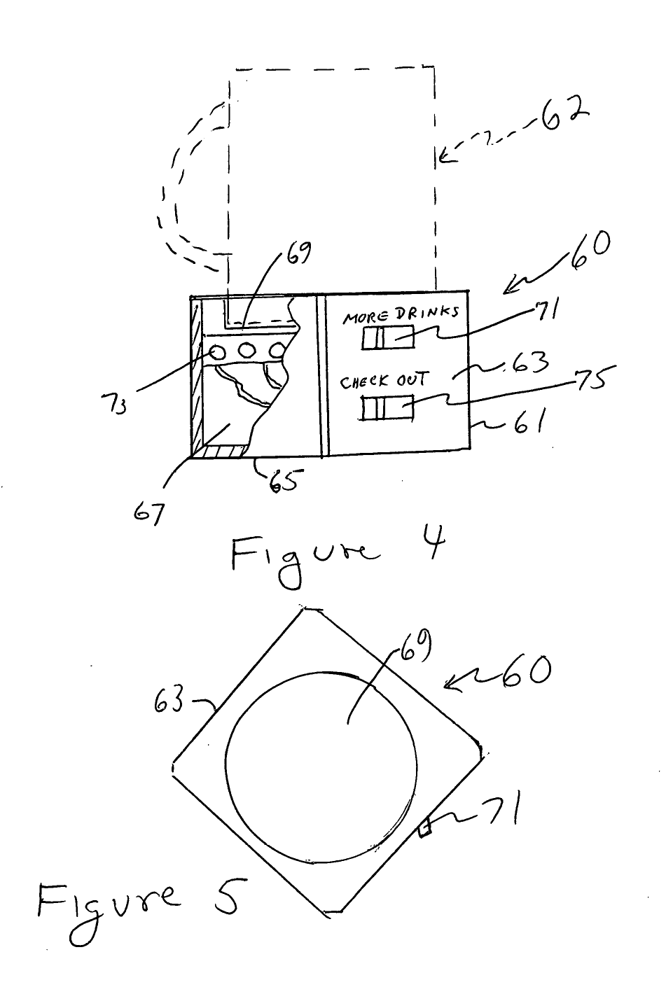

FIG. 5 shows a top view of present invention coaster 60 with identical parts identically numbered.

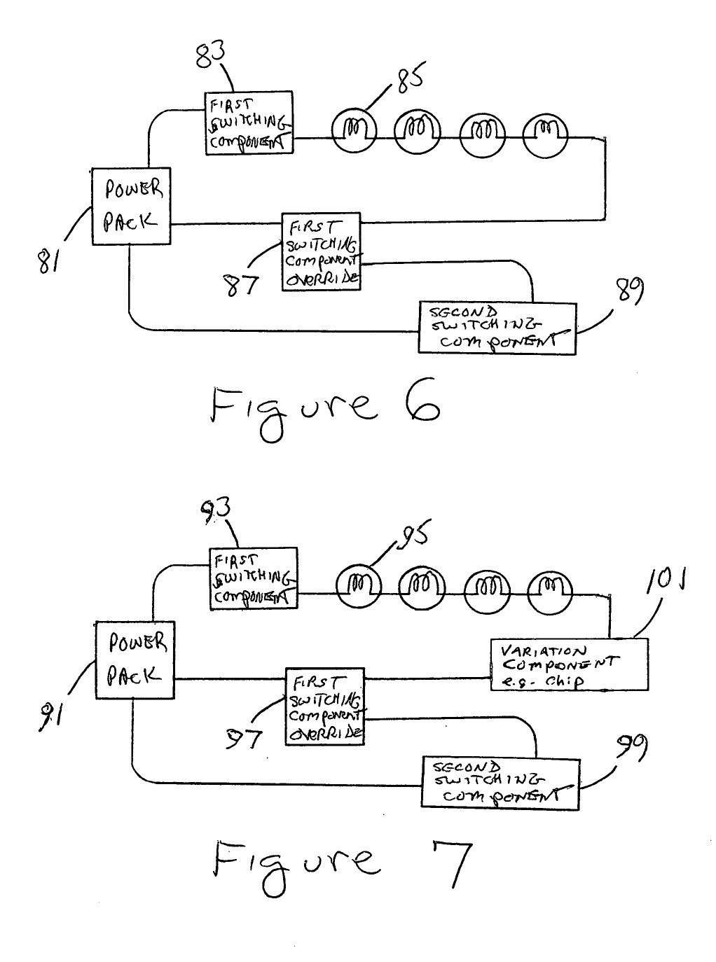

FIG. 6 is a wiring diagram for one embodiment of the present invention coaster with illumination communication that could be used in many embodiments, including the present invention coaster shown in FIG. 3. Block 81 represents a power pack which could be any portable power source such as batteries and fuel cells or a more primitive plug in set up for a 110V or other voltage “house power” with an appropriate transformer. First switching component 83 may be a manual switch or a gravity switch based on whether or not a glass is positioned properly. It is wired from the power pack to lights 85 and the circuit is completed through a first switching override 87. This override passes current to lights 85 for continuous illumination when first switching component 83 is on and second switching component 89 is off. When second switching component 89 is on, then the first switching component, if on, is overridden to illuminate lights 85 in a predetermined pattern, such as blinking. The diagram of FIG. 6 enables a first switching event to turn the lights on to signal for service, such as a drink refill. It also enables a second switching event wherein the lights have a blinking pattern to signal a request for a bill or tab.

FIG. 7 is another wiring diagram for different embodiments of present invention coasters wherein various lighting feature options are included. In FIG. 7, power pack 91 is similar to power pack 81 in FIG. 6. Likewise, first switching component 93 is similar to first switching component 83 of FIG. 6. Lights 95 may be the same or different and may be collectively of a different color (e.g. all red or all green) or may be a combination of different colors. First switching override 97 is similar to first switching override 87 of FIG. 6, hut varistor 96 or other changing components will enable variations in the lighting patterns for lights 95. For example, when first switching component 93 is turned on, white lights might light up and when second switching component 101 is turned on, lights 95 may illuminate in sequence so as to appear to be a single revolving light like a lighthouse or they may light up in one or more different colors. In one variation, the spinning light may accelerate and then decelerate for additional illumination effects.

While FIGS. 6 and 7 show some possible wiring and component arrangements for present invention coasters, other arrangements are clearly within the scope of the present invention and within the purview of the artisan. For example, a single power pack could be used, but different lights and disparate wiring could be used for first switching and for second switching modes.

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims. For example, the actual shape of the main housing may be other than circular and still be within the scope of the present invention. Likewise, present invention coasters with flat bottoms are anticipated, but elevated bottoms with short legs or other variations would be encompassed by the scope of the present invention. Light dispersion features could also be included. Coaster tops could be colored glass with segments of different colors to illuminate multiple colors around and into and through a glass.

What is claimed is:

1. A coaster with illumination communication for signaling a drink refill request and for signaling a check request, which comprises:
a) a base assembly having a flat top for resting a drinking vessel thereon, and having a hollow body for holding illumination, power and switching components, said flat top having at least a portion thereof being at least translucent;
b) an illumination component located in said base assembly positioned to direct light to said flat top;
c) a power component located in said base assembly and connected to said illumination component;
d) a switching component electrically connected to said power component and said illumination component so as to control said illumination component with at least 3 modes, and thus being an at least three mode switching component, said at least three modes being an off mode and two different on modes.

2. The coaster of claim 1 wherein said illumination component is selected from the group consisting of LED lamp, LED flat light sheet and combinations thereof.

3. The coaster of claim 2 wherein said illumination component is a plurality of LED lamps.

4. The coaster of claim 1 wherein said power component is selected from the group consisting of a battery, a fuel cell, and other portable power components.

5. The coaster of claim 4 wherein said base assembly includes an access port for replacing said power component.

6. The coaster of claim 1 wherein said switching component is a three way switch having an off mode position and two diverse powering mode positions.

7. The coaster of claim 6 wherein said three way switch includes an off mode position, one on mode position for steady illumination, and one on mode position for intermittent illumination.

8. The coaster of claim 6 wherein said three way switch includes an off mode position, one on mode position for slow intermittent illumination, and one on mode position for fast intermittent illumination.

9. The coaster of claim 6 wherein said switching component is at least two different on-off two way switches with diverse on modes.

10. The coaster of claim 1 wherein said switching component includes at least one mode that includes a weight-activated mechanism.

11. A method of signaling for a drink refill request and for signaling a check request by a user, with a coaster having illumination communication for said signaling, which method comprises:
A) providing said user with a coaster which includes:
a) a base assembly having a flat top for resting a drinking vessel thereon, and having a hollow body for holding illumination, power and switching components, said flat top having at least a portion thereof being at least translucent;
b) an illumination component located in said base assembly positioned to direct light to said flat top;
c) a power component located in said base assembly and connected to said illumination component;
d) a switching component electrically connected to said power component and said illumination component so as to control said illumination component with at least 3 modes, and thus being an at least three mode switching component, said at least three modes being an off mode and two different on modes, one of said two different on modes being for signaling a request for a drink refill, and the other of said two different on modes for signaling a request for a check; and
B) directing said user to activate one of said two different on modes for signaling a request for a drink refill, and to activate the other of said two different on modes for signaling a request for a check.

12. The method of claim 11 wherein said illumination component is selected from the group consisting of LED lamp, LED flat light sheet and combinations thereof.

13. The method of claim 12 wherein said illumination component is a plurality of LED lamps.

14. The method of claim 11 wherein said power component is selected from the group consisting of a battery, a fuel cell, and other portable power components.

15. The method of claim 14 wherein said base assembly includes an access port for replacing said power component.

16. The method of claim 11 wherein said switching component is a three way switch having an off mode position and two diverse powering mode positions.

17. The method of claim 16 wherein said three way switch includes an off mode position, one on mode position for steady illumination, and one on mode position for intermittent illumination.

18. The method of claim 16 wherein said three way switch includes an off mode position, one on mode position for slow intermittent illumination, and one on mode position for fast intermittent illumination.

19. The method of claim 16 wherein said switching component is at least two different on-off two way switches with diverse on modes.

20. The method of claim 11 wherein said switching component includes at least one mode that includes a weight-activated mechanism.
